(19) United States
(12) Patent Application Publication
(10) Pub. No.: US 2012/0198018 A1
(43) Pub. Date: Aug. 2, 2012

(54) SECURELY PUBLISHING DATA TO NETWORK SERVICE

(75) Inventors: Alexander Malafeev, Frederiksberg (DK); Ievgenii Korovin, Charlottenlund (DK); Dennis Kukurudza, Lund (SE)

(73) Assignee: MICROSOFT CORPORATION, Redmond, WA (US)

(21) Appl. No.: 13/015,453

(22) Filed: Jan. 27, 2011

(51) Int. Cl. G06F 15/16

(52) U.S. Cl. 709/217

(57) ABSTRACT

Data is securely published from a local service to a network service. The data for publishing to the network service is selected using the local service. In response to the data being selected for publishing, the local service creates a secure connection to the network service and transfers the data to the network service. For example, a master data services (MDS) client application may be used to select data from an Enterprise Resource Planning (ERP) server to be published to a network service, such as a network service that provides master data services. The published data is received by the network service and stored in a data store. The data may be stored within the network service such that a user may consume the published data using the network service.

### BACKGROUND

Many people utilize locally based applications and/or web based applications to perform tasks. For example, a user may use a program/service that resides within a local network to interact with different type of data. A user may also use an online application to interact with data in a network service. In some instances, a user may desire to transfer data between the local service and the network service. It can be difficult to securely transfer data between the systems as they are hosted on different servers and usually include different security mechanisms.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Data is securely published from a local service to a network service. The data for publishing to the network service is selected using the local service. In response to the data being selected for publishing, the local service creates a secure connection to the network service and transfers the data to the network service. For example, a master data services (MDS) client application may be used to select data from an Enterprise Resource Planning (ERP) server to be published to a network service, such as a network service that provides master data services. The published data is received by the network service and stored in a data store. The data may be stored within the network service such that a user may consume the published data using the network service.

### BRIEF DESCRIPTION OF THE DRAWINGS

FIG. 1 illustrates an exemplary computing environment;

FIG. 2 shows a system for publishing data from a local service to a network service; and

FIG. 3 shows an illustrative process for securely publishing data.

### DETAILED DESCRIPTION

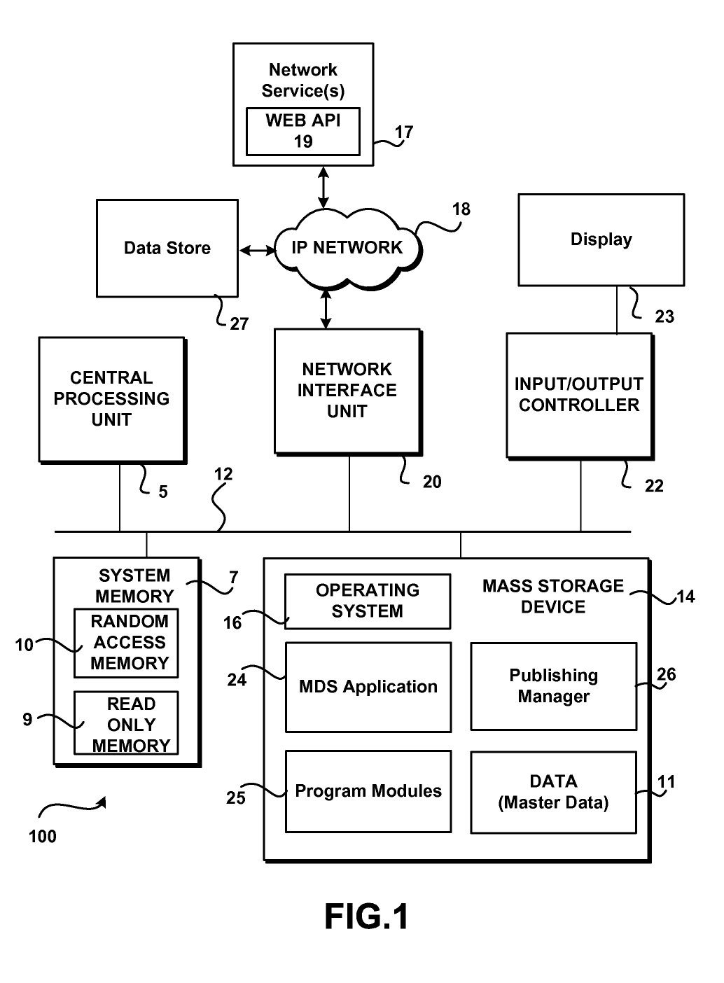

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, data 11, MDS application 24, other program modules 25, and publishing manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to an IP phone, a display screen 23, a printer, or other type of input/output device.

As mentioned briefly above, a number of program modules and data files may be stored in the mass storage device 14 and RAM 9 of the computer 100, including an operating system 16 suitable for controlling the operation of a computer, such as WINDOWS SERVER® or the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs, including MDS application 24 and program modules 25. According to an embodiment, the MDS application 24 is a MICROSOFT CORPORATION application that may be associated with the MICROSOFT DYNAMICS AX application. Other ERP/MDS applications that interact with master data may also be used.

Master data may be many types of data. Generally, master data are the critical nouns of a business and fall generally into four groupings: people, things, places, and concepts. Further categorizations within those groupings are called subject areas, domain areas, or entity types. For example, within people, there are customer, employee, and salesperson. Within things, there are product, part, store, and asset. Within concepts, there are things like contract, warrantee, and licenses. Finally, within places, there are office locations and geographic divisions. Some of these domain areas may be further divided. Customer may be further segmented, based on incentives and history. A company may have normal customers, as well as premiere and executive customers. Product may be further segmented by sector and industry. The requirements, life cycle, and CRUD (created, read, updated, deleted, and searched) cycle for a product in the Consumer Packaged Goods (CPG) sector is likely very different from those of the clothing industry. The granularity of domains is essentially determined by the magnitude of differences between the attributes of the entities within them.

Master data can be described by the way that it interacts with other data. For example, in transaction systems, master data is generally involved with transactional data. A customer buys a product. A vendor sells a part, and a partner delivers a crate of materials to a location. An employee is hierarchically related to their manager, who reports up through a manager (another employee). A product may be a part of multiple hierarchies describing their placement within a store. This relationship between master data and transactional data may be fundamentally viewed as a noun/verb relationship. Transactional data capture the verbs, such as sale, delivery, purchase, email, and revocation; master data are the nouns. This is the same relationship data-warehouse facts and dimensions share.

As cardinality (the number of elements in a set) decreases, the likelihood of an element being treated as a master-data element—even a commonly accepted subject area, such as customer—decreases. For example, if a company has only three customers, most likely they would not consider those customers master data—at least, not in the context of supporting them with a master-data management solution, simply because there is no benefit to managing those customers with a master-data infrastructure. Yet, a company with thousands of customers would consider Customer an important subject area, because of the concomitant issues and benefits around managing such a large set of entities. The customer value to each of these companies is the same. Both rely upon their customers for business. One needs a customer master-data solution; the other does not. Cardinality does not change the classification of a given entity type; however, the importance of having a solution for managing an entity type increases as the cardinality of the entity type increases.

Master data tends to be less volatile than transactional data. As it becomes more volatile, it typically is considered more transactional. For example, some might consider “contract” a master-data element. Others might consider it a transaction. Depending on the lifespan of a contract, it can go either way. An agency promoting professional athletes might consider their contracts as master data. Each is different from the other and typically has a lifetime of greater than a year. It may be tempting to simply have one master-data item called “athlete.” However, athletes tend to have more than one contract at any given time: one with their teams and others with companies for endorsing products. The agency would need to manage all those contracts over time, as elements of the contract are renegotiated or athletes traded. Other contracts—for example, contracts for detailing cars or painting a house—are more like a transaction. They are one-time, short-lived agreements to provide services for payment and are typically fulfilled and destroyed within hours.

Simple entities, even valuable entities, are rarely a challenge to manage and are rarely considered master-data elements. The less complex an element, the less likely the need to manage change for that element. Typically, such assets are simply collected and tallied. For example, Fort Knox likely would not track information on each individual gold bar stored there, but rather only keep a count of them. The value of each gold bar is substantial, the cardinality high, and the lifespan long; yet, the complexity is low.

The more valuable the data element is to the company, the more likely it will be considered a master data element. Value and complexity work together.

While master data is typically less volatile than transactional data, entities with attributes that do not change at all typically not classified as master data. For example, rare coins would seem to meet many of the criteria for a master-data treatment. A rare-coin collector would likely have many rare coins. So, cardinality is high. They are valuable. They are also complex. For example, rare coins have a history and description. There are attributes, such as condition of obverse, reverse, legend, inscription, rim, and field. There are other attributes, such as designer initials, edge design, layers, and portrait.

Yet, rare coins do not need to be managed as a master-data item, because they don't change over time—or, at least, they don't change enough. There may need to be more information added, as the history of a particular coin is revealed or if certain attributes must be corrected. But, generally speaking, rare coins would not be managed through a master-data management system, because they are not volatile enough to warrant a solution.

One of the drivers of master-data management is reuse. For example, in a simple world, the CRM system would manage everything about a customer and not need to share any information about the customer with other systems. However, in today's complex environments, customer information needs to be shared across multiple applications. That's where the trouble begins. Because—for a number of reasons—access to a master datum is not always available, people start storing master data in various locations, such as spreadsheets and application private stores. There are still reasons, such as data-quality degradation and decay, to manage master data that is not reused across the enterprise. However, if a master-data entity is reused in multiple systems, it's a sure bet that it should be managed with a master-data management system.

While it is simple to enumerate the various master-data entity types, it is sometimes more challenging to decide which data items in a company should be treated as master data. Often, data that does not normally comply with the definition for master data may need to be managed as such, and data that does comply with the definition may not. Ultimately, when deciding on what entity types should be treated as master data, it is better to categorize them in terms of their behavior and attributes within the context of the business needs than to rely on simple lists of entity types.

According to an embodiment, the publishing manager 26 is a component within the MDS application 24 of the client computing device. The publishing manager 26, however, may be located externally from the MDS application.

Publishing manager 26 is configured to securely publish data to a network server/service 17.

A client application, such as MDS application 24, interacts with data that is local to the MDS application. For example, one or more ERP servers may contain data and master data to publish to the network service. Data is securely published from a local service, such as MDS application to a web based service, such as network service 17. The data for publishing to the network service is selected using the local service. In response to the data being selected for publishing, publishing manager 26 creates a secure connection to the network service 17 and transfers the data to the network based service. For example, master data services (MDS) client application 24 may be used to select data that is contained on an Enterprise Resource Planning (ERP) server, or some other location, to be published to network service 17. Network service 17 is configured to provide services that interact with master data. The published data is received by network service 17 and stored in a data store, such as data store 27. The data may also be stored directly within the network service. The published master data may be consumed through a web based interface and/or some other interface.

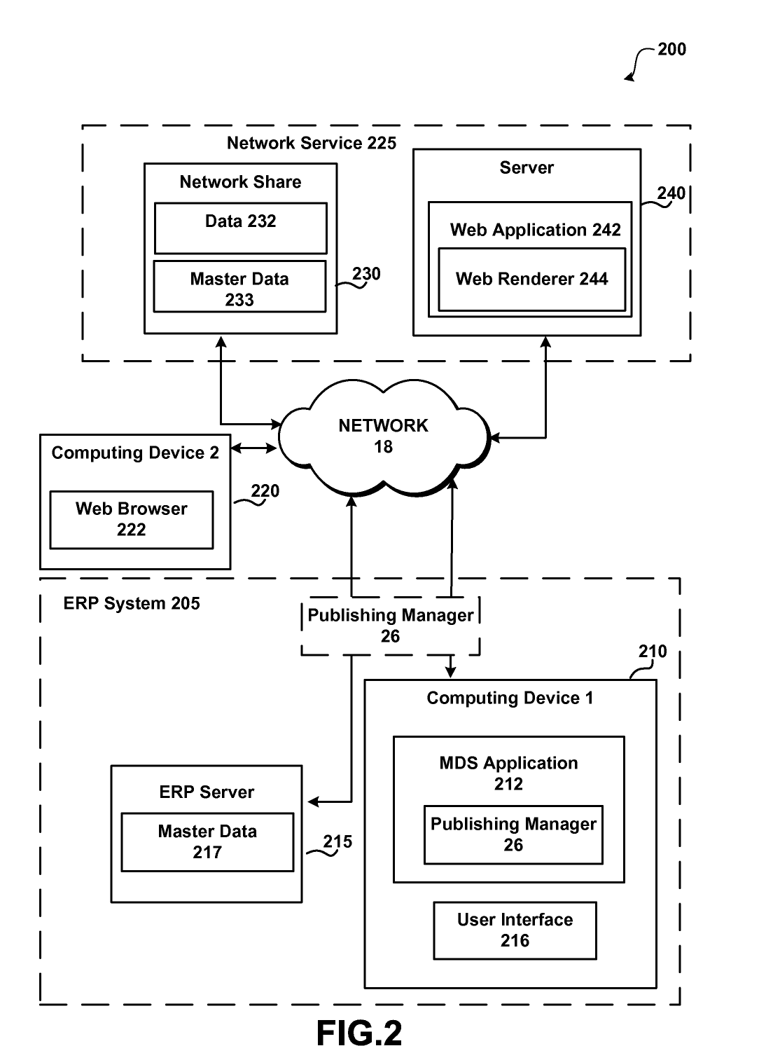

FIG. 2 shows a system for publishing data from a local service to a network service. As illustrated, system 200 includes ERP system 205, network service 225 and computing device 2 (220). ERP system comprises computing device 1 (210), publishing manager 26 and ERP server 215. Network service 225 comprises network share 230 and server 240. More or less computers may be configured to operate within the system illustrated in FIG. 2.

The computing devices may be configured in different ways. For example, some of the computing devices may be: mobile computing devices (e.g. cellular phones, tablets, smart phones, laptops, and the like); desktop computing devices and servers. Network service 225 may be arranged to provide an online cloud based service (e.g. an ERP/MDS service for interacting with master data), some may be arranged as data shares, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as computing device 1, network share 230 and network service 240.

Computing device 1 includes MDS application 212 and user interface 216. As illustrated, computing device 1 is used by a user to interact with master data, such as master data 217 stored within ERP server 215. Master data may be stored in many different locations. For example, one or more data stores may be used to store master data relating to ERP system 205.

User interface (UI) 216 is used to interact with an application, such as MDS application 212. For example, UI 216 may be used select a table/view which is to be published to network service 225. According to an embodiment, the network service 225 provides master data services. Once the selected data is published to network service 225, the network service automatically creates a corresponding table/view and starts pooling data from/to ERP system 205 to/from network service 225.

Computing device 2 includes one or more applications, such as web browser 222 that may be configured to view/enter/interact with master data that is published to network service 225. For example, web browser 222 may be used to access a server, such as server 240, within network service 225 that provides master data services.

Network service 225 includes server 240 and network share 230. Server 240 comprises web application 242 that comprises web renderer 244. Web application 242 is configured for receiving and responding to requests relating to master data services. For example, server 240 may access master data 233 or other data stored on network share 230. Web application 242 is operative to provide an interface to a user of a computing device, such as a mobile computing device or some other computing device (e.g. computing device 2) to interact with master data via network 18.

Network service 225 receives requests from computing devices, such computing device 1 to receive published data, such as master data. A client application, such as MDS application 212, interacts with data that within ERP system 205. For example, one or more ERP servers, such as ERP server 215, may contain data and master data that is published to network service 225.

In response to data being identified to be published, publishing manager 26 establishes a secure connection with network service 225. According to an embodiment, the connection is established from ERP system 205 to network service 225. Establishing the connection from the ERP system alleviates the ERP server from opening an incoming connection from a location that is outside of the ERP system. The connection may be automatically closed. For example, the connection may be automatically closed after the identified data is pushed to network service 225, after a predetermined time period has expired (e.g. 5 minutes) or after some other condition.

The data for publishing to network service 225 may be identified in different manners. A user may select the data using user interface 216. For example, master data services (MDS) client application 212 and UI 216 may be used to select data 217 that is contained in ERP server 215, or some other location, to be published to network service 225. When data, such as master data 217, is changed, the changed data may be identified to publish. Generally a user will select the data to publish to network service 225. The data that is identified for publishing may be marked such that the data to publish is identifiable from other data that is not to be published. For example, a publishing flag may be set. The data to be published may also be stored within a memory/data store, such as a buffer, before being published.

After the secure connection is established, publishing manager 26 transfers the data to the network service. The published data is received by network service 225 through the established connection and is stored in a data store, such as network share 230. The data may be transferred at different times. For example, publishing manager 26 may be configured to periodically check to determine whether there is data to be published to network service 225 (e.g. every 5 minutes, 30 minutes, every hour, twice a day, each day, and the like). The data may also be published in response to receiving a selection of data to be published. The data may also be published once an amount of data exceeds a predetermined threshold (e.g. more than 50 k of data, 1 megabyte of data, and the like).

A computing device, such as computing device 2, may access the published data. For example, the published data may be consumed through a web based interface, such as web browser 222, and/or some other interface. According to an embodiment, the published master data is marked as read only data within network service 225.

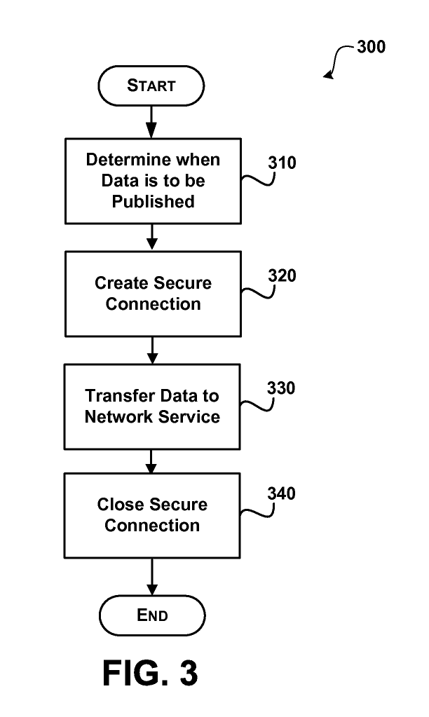

Referring now to FIG. 3 an illustrative process for securely publishing data will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start block, process 300 moves to operation 310, where a determination is made as to when data is to be published to a network service. As discussed, the determination of which data to publish may be made using different methods. For example, a user may select the data to publish, changed data may be automatically identified to be published, data identified by a project may be identified to be published, and the like.

Moving to operation 320, a secure connection is created between the local service and the network service. According to an embodiment, the local service is an ERP system and the network service provides services for interacting with master data. According to an embodiment, the secure connection originates from the local service.

Flowing to operation 330, the data to publish is transferred to the network service. Different trigger points may be used to determine when to transfer the data to the network service. For example, the data may be published at predetermined times to the network service (every 5 minutes, 30 minutes, every hour, twice a day, each day, and the like). The data may also be published in response to receiving a selection of data to be published. The data may also be published once an amount of data exceeds a predetermined threshold (e.g. more than 50 k of data, 1 megabyte of data, and the like).

Transitioning to operation 440, the secure connection is closed. The secure connection may be manually closed and/or automatically closed. For example, the connection may be automatically closed after the identified data is published to the network service, after a predetermined time period has expired (e.g. 5 minutes) or after some other condition.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for publishing data from a local service to a network service, comprising:
determining when data is to be published from the local service to the network service; wherein at least a portion of the data is master data;
creating a secure connection from the local service to the network service; and
pushing the data to be published from the local service to the network service.

2. The method of claim 1, wherein the local service obtains the data from an Enterprise Resource Planning (ERP) server within a local network.

3. The method of claim 2, wherein the network service provides master data management services.

4. The method of claim 1, further comprising automatically closing the secure connection to the network service after the data is pushed to the network service.

5. The method of claim 1, wherein determining when data is to be published from the local service to the network service comprises receiving a selection of data to publish through a graphical user interface that is associated with a master data management application.

6. The method of claim 1, wherein determining when data is to be published from the local service to the network service comprises periodically performing a check to determine when data has been marked for publishing.

7. The method of claim 1, wherein determining when data is to be published from the local service to the network service comprises determining when an amount of data to publish exceeds a predetermined threshold.

8. The method of claim 1, wherein the network service creates corresponding entities based on a selection of the data to be published.

9. The method of claim 1, wherein the data published to the network service is read only master data when interacted with through the network service.

10. A computer-readable storage medium storing computer-executable instructions for publishing data from a local service to a network service, comprising:
determining when master data is to be published from the local service to the network service; wherein the local service obtains the master data from an Enterprise Resource Planning (ERP) server;
creating a secure connection from the local service to the network service; and
pushing the data to be published from the local service to the network service.

11. The computer-readable storage medium of claim 10, wherein the network service provides master data management services.

12. The computer-readable storage medium of claim 10, further comprising automatically closing the secure connection to the network service after the data is pushed to the network service.

13. The computer-readable storage medium of claim 10, wherein determining when the master data is to be published from the local service to the network service comprises receiving a selection of data to publish through a graphical user interface that is associated with a master data management application.

14. The computer-readable storage medium of claim 10, wherein determining when master data is to be published from the local service to the network service comprises periodically performing a check to determine when master data has been marked for publishing.

15. The computer-readable storage medium of claim 10, wherein determining when master data is to be published from the local service to the network service comprises determining when an amount of master data to publish exceeds a predetermined threshold.

16. The computer-readable storage medium of claim 10, wherein the master data published to the network service is read only master data when interacted with through the network service.

17. A system for publishing data from a local service to a network service, comprising:
a network service;
an Enterprise Resource Planning (ERP) server that stores master data;
a display;
a network connection that is configured to connect to a network;
a processor, memory, and a computer-readable storage medium;
an operating environment stored on the computer-readable storage medium and executing on the processor;
a client application for interacting with master data; and
a publishing manager operating in conjunction with the client application that is configured to perform actions, comprising:
determining when master data is to be published to the network service;
creating a secure connection to the network service;
pushing the data to be published to the network service; and
closing the secure connection to the network service after the data is pushed to the network service.

18. The system of claim 17, wherein determining when master data is to be published to the network service comprises receiving a selection of master data to publish through a graphical user interface.

19. The system of claim 17, wherein determining when master data is to be published comprises periodically performing a check to determine when master data has been marked for publishing.

20. The system of claim 17, wherein determining when master data is to be published comprises determining when an amount of master data to publish exceeds a predetermined threshold.
